(19) United States
(12) Patent Application Publication
(10) Pub. No.: US 2005/0285981 A1
(43) Pub. Date: Dec. 29, 2005

(54) COMBINATION STRUCTURE OF COLOR WHEEL

(76) Inventors: Sze-Ke Wang, Miao-Li County (TW); Nien-Hui HSU, Miao-Li County (TW)

Correspondence Address: NORTH AMERICA INTELLECTUAL PROPERTY CORPORATION, P.O. BOX 506, MERRIFIELD, VA, 22116, US

(21) Appl. No.: 10/908,915

(22) Filed: Jun. 1, 2005

(30) Foreign Application Priority Data
Jun. 16, 2004 (TW) 093117434

(51) Int. Cl. H04N 5/74; G02F 1/00

(52) U.S. Cl. 348/753

(57) ABSTRACT

The present invention relates to a combination structure of a color wheel. The color wheel is composed of a motor and a plurality of color filters. The motor has a rotating shaft. The plurality of color filters is disposed on the motor and joined to become a ring shape around the rotating shaft, and is rotated by the motor. The plurality of color filters comprises a first color filter and a second color filter that are next to each other, and the contacting border of the first color filter and the second color filter is a turning line segment so as to make the first color filter and the second color filter tightly wedged.

### BACKGROUND OF THE INVENTION

1. Field of the Invention

The present invention relates to a combination structure of a color wheel, and more particularly, to a color wheel applied in a projection apparatus.

2. Description of the Prior Art

In a projection apparatus, the color wheel is an important optical part for a light beam to pass through and to change the original color of the light beam. The color wheel also operates in coordination with the light valve to adjust the color contrast.

Please refer to FIG. 1 and FIG. 2. FIG. 1 is the upper plan view of the conventional color wheel 10, and FIG. 2 is the lateral view of the conventional color wheel 10. The conventional color wheel 10 is composed of a motor 11, a red color filter 121, a green color filter 122 and a blue color filter 123. Each of the red color filter 121, the green color filter 122 and the blue color filter 123 has a glue area 124 and is adhered to the motor 11 by the glue 13.

In the design of the conventional color wheel 10, the contacting border of the red color filter 121, the green color filter 122 and the blue color filter 123 is a straight line segment 15 that extending directions of the straight line segment 15 pass through the axis of the rotating shaft 141. Since that there is no tightly wedged design between the contacting border of the red color filter 121, the green color filter 122 and the blue color filter 123, the quality of the glue 13 will become poorer due to rotation of the color wheel 10 under a high speed and a high temperature. There can be a situation that the red color filter 121, the green color filter 122 and the blue color filter 123 are easy to be separated from the motor 11.

### SUMMARY OF THE INVENTION

One objective of the present invention is to provide a combination structure of a color wheel in order to solve the above-mentioned problems encountered in the prior art.

The present invention is to provide a combination structure of a color wheel, wherein the contacting border of each color filter of the color wheel is tightly wedged by the complementary structure. Therefore, when the color wheel rotates at a high speed under a high temperature and the quality of the glue becomes poorer, the tightly wedged structure of the contacting border of each color filter can hold the structure of the color wheel and consequently the color filters do not go to pieces.

The advantage and the sprit of the present invention can be found out by the following detailed description and the attached figures.

These and other objectives of the present invention will no doubt become obvious to those of ordinary skill in the art after reading the following detailed description of the preferred embodiment that is illustrated in the various figures and drawings.

### DESCRIPTION OF THE DRAWINGS

FIG. 1 is the upper plan view of the conventional color wheel.

FIG. 2 is the lateral view of the conventional color wheel.

FIG. 3 is the upper plan view of the color wheel in the first preferred embodiment of the present invention.

FIG. 4 is the lateral view of the color wheel in the first preferred embodiment of the present invention.

FIG. 5 is the upper plan view of the color wheel in the second preferred embodiment of the present invention.

FIG. 6 is the upper plan view of the color wheel in the third preferred embodiment of the present invention.

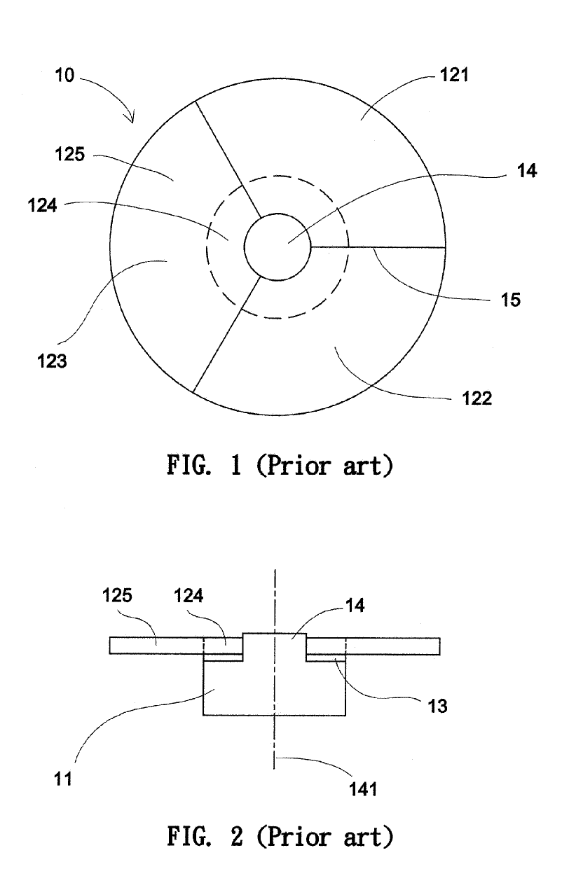

### DETAILED DESCRIPTION

To make it easier to understand the objective of the invention, we use three preferred embodiments together with the attached drawings for the detailed description of the invention.

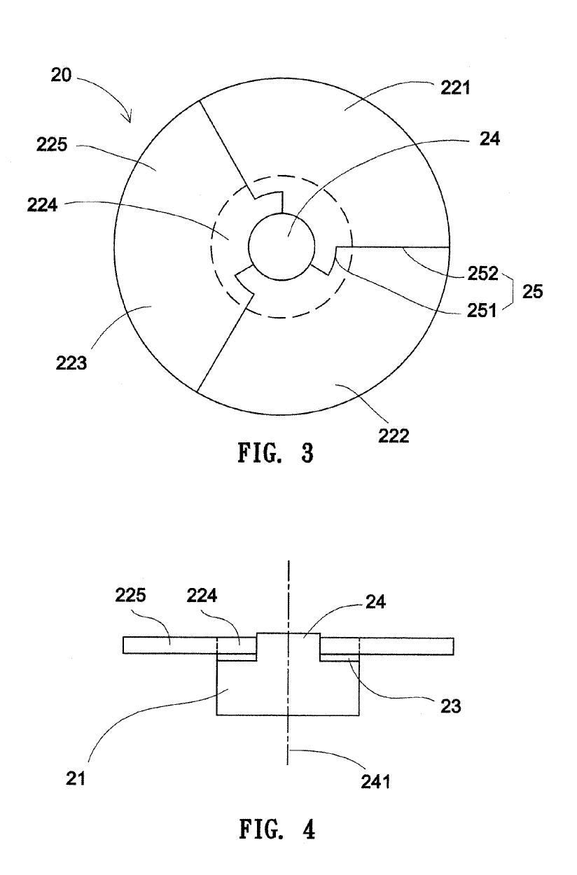

Please refer to FIG. 3 and FIG. 4. FIG. 3 is the upper plan view of the color wheel 20 in the first preferred embodiment of the present invention, and FIG. 4 is the lateral view of the color wheel 20 in the first preferred embodiment of the present invention. The color wheel 20 of the present invention is composed of a motor 21, a red color filter 221, a green color filter 222 and a color filter 223, wherein the motor 21 has a rotating shaft 24 in order to drive the filters to rotate. The red color filter 221, the green color filter 222 and the color filter 223 are disposed on the motor 21 and joined to become a ring shape around the rotating shaft 24, wherein each color filter has a glue area 224 and a transparent area 225, and the transparent area 225 is located on the color filter except the glue area 224. By taking advantage of the glue 23, the glue area 224 is stuck to the motor 21. The contacting boarder of the red color filter 221, the green color filter 222 and the blue color filter 223 is a turning line segment 25, and the turning line segment 25 is composed of a turning segment 251 and a straight segment 252. The turning segment 251 is disposed in the glue area 224 and the straight segment 252 is disposed in the transparent area 225. By the structure of the turning line segment 25, the red color filter 221, the green color filter 222 and the blue color filter 223 are tightly wedged.

The turning segment 251 with wedging function is disposed in the glue area 224, and the straight segment 252 is disposed in the transparent area, therefore it is easy to detect the color change at the contacting boarder of each color filter when using the color wheel, and the light valve can process the color change immediately in order to provide the projected images with a better quality.

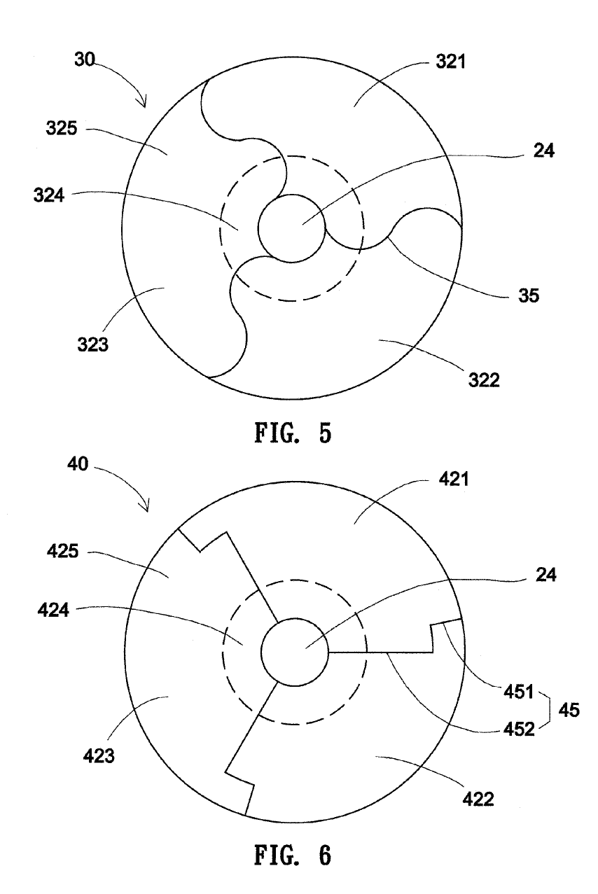

Please refer to FIG. 5, which is the upper plan view of the color wheel 30 in the second preferred embodiment of the present invention. The contacting boarder of the red color filter 321, the green color filter 322 and the blue color filter 323 is a turning line segment 35, and the turning line segment 35 is a curve in order to make the red color filter 321, the green color filter 322 and the blue color filter 323 tightly wedged.

Please refer to FIG. 6, which is the upper plan view of the color wheel 40 in the third preferred embodiment of the present invention. The contacting boarder of the red color filter 421, the green color filter 422 and the blue color filter 423 is a turning line segment 45, and the turning line segment 45 is composed of a turning segment 451 and a straight segment 452, the turning segment 451 is disposed in the transparent area 425 and the straight segment 452 is disposed both in the transparent area 425 and the glue area 424 in order to make the red color filter 421, the green color filter 422 and the blue color filter 423 tightly wedged.

Compared to the conventional color wheel, each color filter of the color wheel in the present invention is tightly wedged by the complementary structure. Therefore, when the color wheel rotates at a high speed under a high temperature and the quality of the glue become poorer, the tightly wedged structure of the contacting border of each color filter can hold the structure of the color wheel and consequently the color filters do not go to pieces.

Although the invention has been described in detail herein with reference to its preferred embodiments, it is to be understood that this description is by way of example only, and is not to be interpreted in a limiting sense. It is to be further understood that numerous changes in the details of the embodiments of the invention, and additional embodiments of the invention, will be apparent, and may be made by persons of ordinary skill in the art having reference to this description. It is considered that such changes and additional embodiments are within the spirit and true scope of the invention as claimed below.

Those skilled in the art will readily observe that numerous modifications and alterations of the device and method may be made while retaining the teachings of the invention. Accordingly, the above disclosure should be construed as limited only by the metes and bounds of the appended claims.

1. A color wheel, comprising:
a motor having a rotating shaft, and
a plurality of color filters disposed on the motor and joined to become a ring shape around the rotating shaft, the plurality of color filters being rotated by the motor, wherein the plurality of color filters comprises a first color filter and a second color filter, and the contacting border of the first color filter and the second color filter is a turning line segment for the first color filter and the second color filter to be tightly wedged.

2. The color wheel according to claim 1, wherein the turning line segment includes at least one turning segment and at least one straight segment.

3. The color wheel according to claim 2, wherein extending directions of the straight segment pass through the axis of the rotating shaft.

4. The color wheel according to claim 1, wherein the turning line segment is a curve.

5. The color wheel according to claim 1, wherein the plurality of color filters is composed of a glue area and a transparent area and the plurality of color filters is adhered to the motor by the glue area.

6. The color wheel according to claim 5, wherein the turning line segment includes at least one straight segment and at least one turning segment, and the straight segment is located at the transparent area, the turning segment being located at the glue area.

7. The color wheel according to claim 5, wherein the turning line segment includes at least one straight segment and at least one turning segment, and the straight segment is located at the glue area, the turning segment being located at the transparent area.
